(19) United States
(12) Patent Application Publication
(10) Pub. No.: US 2025/0109764 A1
(43) Pub. Date: Apr. 3, 2025

(54) HIGH TORQUE TRANSMISSION FASTENER AND DRIVING TOOL THEREFOR

(71) Applicant: KWANTEX RESEARCH INC., Tainan City (TW)

(72) Inventor: Chao-Wei LIN, Tainan City (TW)

(21) Appl. No.: 18/441,294

(22) Filed: Feb. 14, 2024

(30) Foreign Application Priority Data
Sep. 28, 2023 (TW) 112137427

(51) Int. Cl. F16B 23/00; F16B 25/10

(52) U.S. Cl. CPC F16B 23/003; F16B 25/103; F16B 23/0069

(57) ABSTRACT

A fastener includes a screw head that includes a driven protrusion having four driven wall portions and four guiding wall portions which are disposed about a central axis of the fastener in an alternating arrangement. The driven wall portions are equiangularly spaced apart from each other. Each of the guiding wall portions is straight, and has two opposite ends that are respectively connected to two of the driven wall portions adjacent to the guiding wall portion. A ratio of a longest distance between two of the driven wall portions that are non-adjacent to each other to a longest distance between two of the driven wall portions that are adjacent to each other is greater than 1.16. Each of the driven wall portions has a curved section and two straight sections. A central angle of the curved section of each of the driven wall portions is smaller than 180 degrees.

### CROSS-REFERENCE TO RELATED APPLICATION

This application claims priority to Taiwanese Invention Patent Application No. 112137427, filed on Sep. 28, 2023, the entire disclosure of which is incorporated by reference herein.

### FIELD

The disclosure relates to a fastener and a tool for driving the fastener, and more particularly to a high torque transmission fastener and a driving tool therefor.

### BACKGROUND

A conventional flanged hexagon screw includes an abutting seat that is in the shape of a circular plate, and a hexagonal protrusion that protrudes from the abutting seat. The hexagonal protrusion of the conventional flanged hexagon screw is for a wrench or a driving tool that has a hexagonal hole to grip so that the driving tool or the wrench may drive the conventional flanged hexagon screw to rotate. However, the hexagonal protrusion has a plurality of sharp edges that are formed on an outer surface thereof, and the sharp edges may easily be worn when the conventional flanged hexagon screw is driven by the driving tool/wrench to rotate. When the sharp edges of the hexagonal protrusion are worn, the outer surface of the hexagonal protrusion may become curved, and a contact area between the hexagonal protrusion and the driving tool/wrench is decreased. A torque exerted by a user may thus not be sufficiently transmitted to the conventional flanged hexagon screw. In addition, if the sharp edges are greatly worn out, the driving tool/wrench may slip off the conventional flanged hexagon screw when the user uses the driving tool/wrench to turn the conventional flanged hexagon screw. Consequently, the conventional flanged hexagon screw may not be able to be driven by the driving tool/wrench to rotate.

### SUMMARY

Therefore, an object of the disclosure is to provide a fastener that may not be worn easily and that may not cause a driving tool/wrench which drives the fastener to slip off easily.

According to the disclosure, the fastener includes a screw head and a screw shank. The screw head includes a driven protrusion that has four driven wall portions and four guiding wall portions disposed about a central axis of the fastener in an alternating arrangement. The driven wall portions are equiangularly spaced apart from each other. Each of the guiding wall portions is straight, and has two opposite ends that are respectively connected to two of the driven wall portions adjacent to the guiding wall portion. A ratio of a longest distance between two of the driven wall portions that are non-adjacent to each other to a longest distance between two of the driven wall portions that are adjacent to each other is greater than 1.16. Each of the driven wall portions has a curved section that defines an arc of a circle and that has two opposite ends, and two straight sections each of which extends from a respective one of the ends of the curved section and interconnects the respective one of the ends of the curved section and a respective one of two of the guiding wall portions adjacent to the driven wall portion. A central angle of the curved section of each of the driven wall portions is smaller than 180 degrees. The screw shank extends from one side of the screw head that is distal from the driven protrusion of the screw head in an axial direction of the central axis, and has at least one thread that helically extends therealong.

Another object of the disclosure is to provide a driving tool that can alleviate at least one of the drawbacks of the prior art.

According to the disclosure, the driving tool is adapted for driving the fastener, and includes a main body. The main body has four driving wall portions and four guiding wall portions that are disposed about a central axis of the driving tool in an alternating arrangement. The driving wall portions of the main body are equiangularly spaced apart from each other. Each of the guiding wall portions of the main body is straight, and has two opposite ends that are respectively connected to two of the driving wall portions of the main body adjacent to the guiding wall portion of the main body. The driving wall portions and the guiding wall portions of the main body cooperatively define a driving socket. A ratio of a longest distance between two of the driving wall portions of the main body that are non-adjacent to each other to a longest distance between two of the driving wall portions of the main body that are adjacent to each other is greater than 1.16. Each of the driving wall portions of the main body has a curved section that defines an arc of a circle and that has two opposite ends, and two straight sections each of which extends from a respective one of the ends of the curved section of the main body and interconnects the respective one of the ends of the curved section of the main body and a respective one of two of the guiding wall portions of the main body adjacent to the driving wall portion of the main body. A central angle of the curved section of each of the driving wall portions of the main body is smaller than 180 degrees.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an embodiment of a fastener according to the disclosure.

FIG. 2 is a top view of a screw head of the fastener.

FIG. 3 is a schematic view illustrating a driven protrusion of the screw head.

FIGS. 4 and 5 are perspective views illustrating different configurations of the fastener.

FIGS. 6 to 11 are top views illustrating different configurations of a recess of the driven protrusion.

FIG. 12 is a sectional view illustrating the recess of the fastener and

a conventional driver bit.

FIG. 13 is a perspective view of an embodiment of a driving tool according to the disclosure and the fastener.

FIG. 14 is a top view of a driving socket of the driving tool.

FIG. 15 is a schematic view illustrating a conventional wrench driving the fastener.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

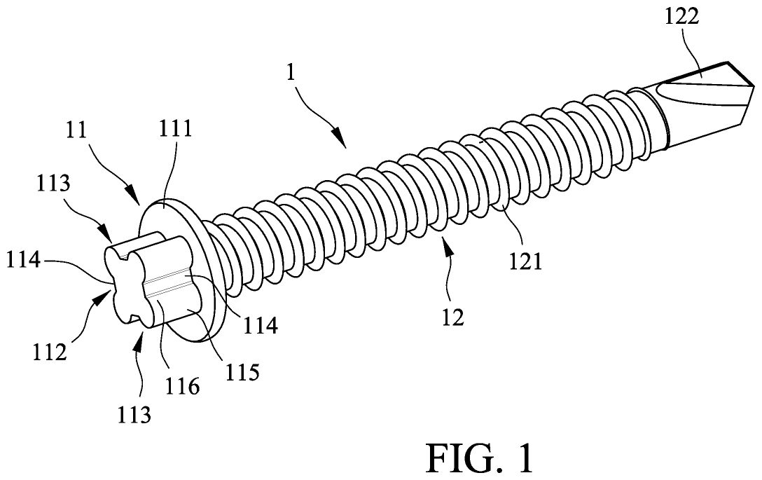

Referring to FIGS. 1 to 3, an embodiment of a fastener 1 according to the disclosure includes a screw head 11 and a screw shank 12. The screw head 11 includes an abutment seat 111 that is disk-shaped and that is connected to the screw shank 12, and a driven protrusion 112 that protrudes from one side of the abutment seat 111 opposite to the screw shank 12. The driven protrusion 112 has four driven wall portions 113 and four guiding wall portions 114 that are disposed about a central axis of the fastener 1 in an alternating arrangement. The driven wall portions 113 are equiangularly spaced apart from each other. Each of the guiding wall portions 114 is straight, and has two opposite ends that are respectively connected to two of the driven wall portions 113 adjacent to the guiding wall portion 114. A ratio of a longest distance (B) between two of the driven wall portions 113 that are non-adjacent to each other to a longest distance (A) between two of the driven wall portions 113 that are adjacent to each other is greater than 1.16 (i.e., (B) divided by (A) is greater than 1.16). Each of the driven wall portions 113 has a curved section 115 that defines an arc of a circle and that has two opposite ends, and two straight sections 116 each of which extends from a respective one of the ends of the curved section 115 and interconnects the respective one of the ends of the curved section 115 and a respective one of two of the guiding wall portions 114 adjacent to the driven wall portion 113. A radius of curvature (C) of the curved section 115 of each of the driven wall portions 113 is greater than a length (D) of each of the straight sections 116 of the driven wall portion 113. A central angle of the curved section 115 of each of the driven wall portions 113 is smaller than 180 degrees, an arc length of the curved section 115 of each of the driven wall portions 113 on an imaginary plane perpendicular to the central axis of the fastener 1 is thus shorter than half of a circumference of the circle defined by the curved section 115 of the driven wall portion 113. The screw shank 12 extends from one side of the screw head 11 that is distal from the driven protrusion 112 of the screw head 11 in an axial direction of the central axis, and has a thread 121 that helically extends therealong, and an end section 122 that is formed on one end of the thread 121 opposite to the screw head 11. Specifically, in this embodiment, the screw shank 12 and the driven protrusion 112 are respectively connected to two opposite surfaces of the abutment seat 111 in the axial direction of the central axis.

It is noted that, in one embodiment, the abutment seat 111 may not be disk-shaped, and may be shaped differently according to actual requirements. Furthermore, in one embodiment, the abutment seat 111 may be omitted such that the driven protrusion 112 is directly connected to another end of the screw shank 12 opposite to the end section 122 of the screw shank 12.

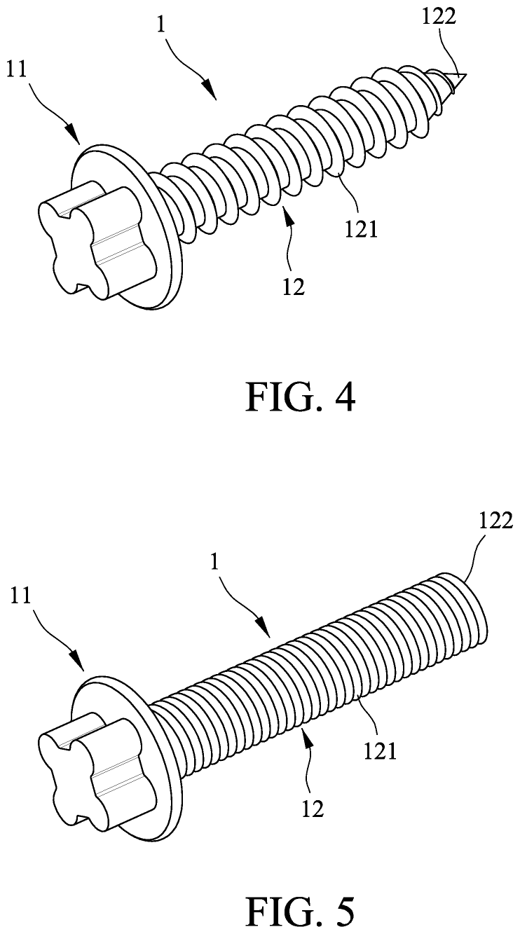

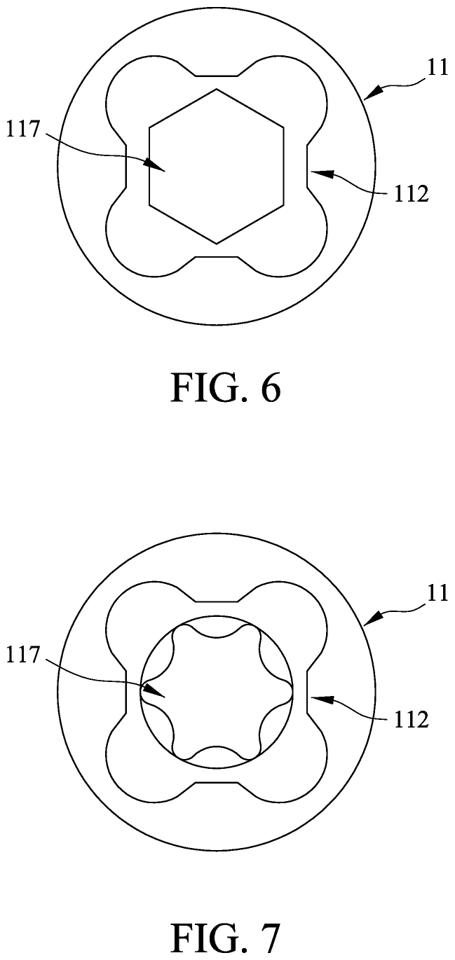

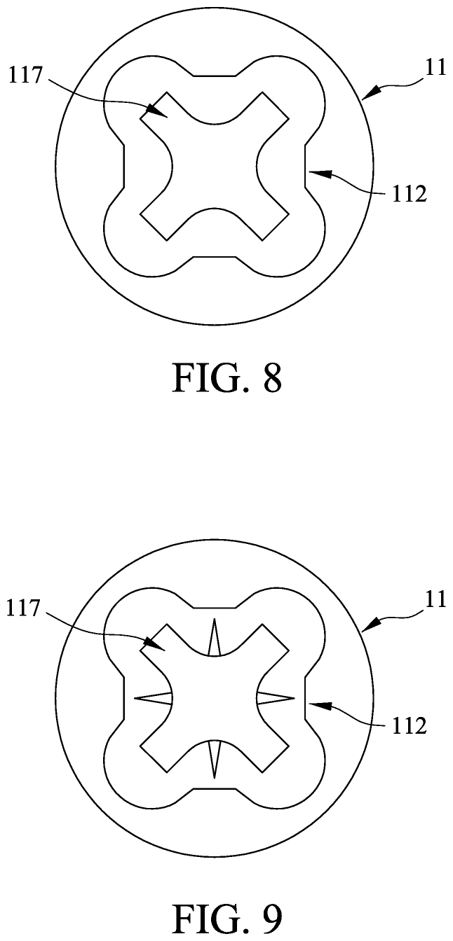

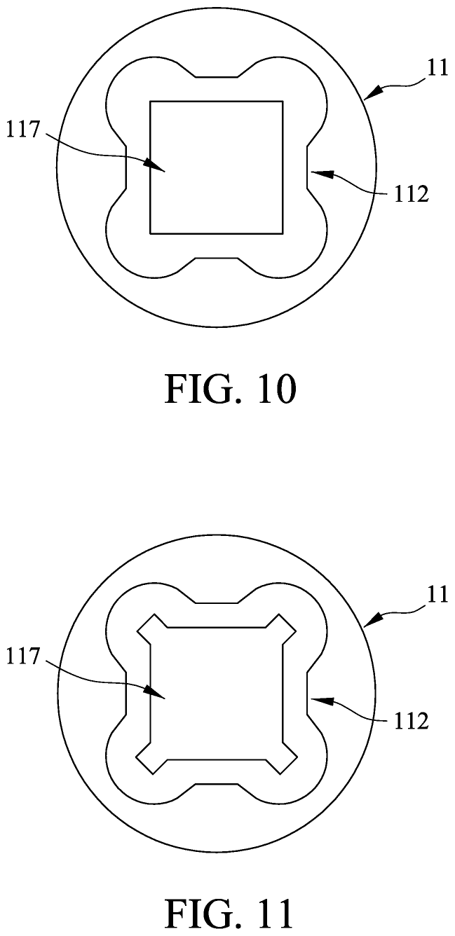

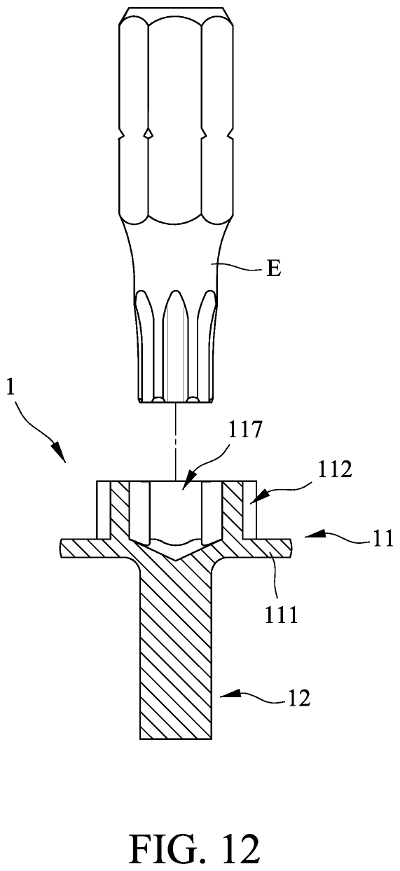

Referring further to FIGS. 4 and 5, in cooperation with FIG. 1, the end section 122 of the screw shank 12 may have different configurations according to actual requirements. For example, as shown in FIG. 1, the end section 122 is configured to be a drilling end. As shown in FIG. 4, the end section 122 is configured to be a pointed end. As shown in FIG. 5, the end section 122 is configured to be a blunt/flat end. Referring to FIGS. 6 to 12, the driven protrusion 112 of the screw head 11 has a surface opposite to the screw shank 12, and a recess 117 that is recessed from the surface along the axial direction of the central axis. A cross section of the recess 117 of the screw head 11 on the imaginary plane perpendicular to the central axis is configured to be one of a hexagonal shape (see FIG. 6), a hexalobular shape (see FIG. 7), a cruciform shape (see FIG. 8), an asterisked shape (see FIG. 9), a quadrilateral shape (see FIG. 10), and a shape of a combination of a cross and a quadrilateral (see FIG. 11). The recess 117 of the screw head 11 is adapted for a driver bit that corresponds in shape to the cross section of the recess 117 to insert thereinto. As shown in FIG. 12, a common driver bit (E) may be used for driving the fastener 1. Thus, the fastener 1 may be used for more purposes.

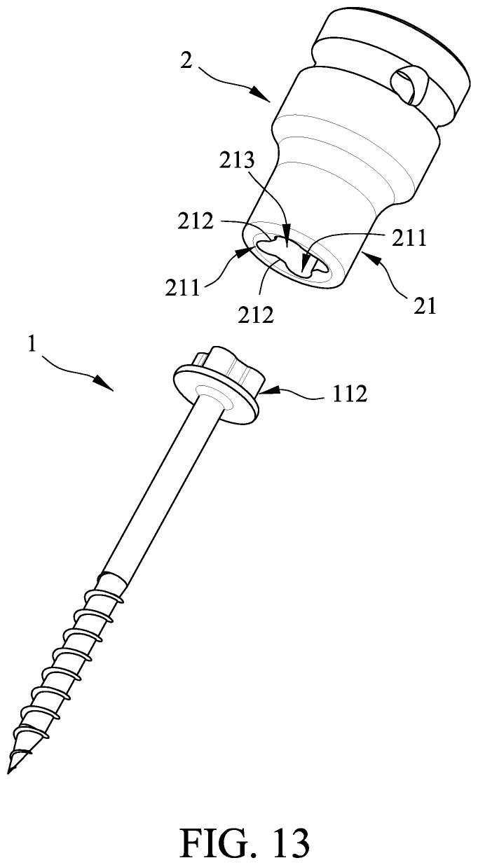

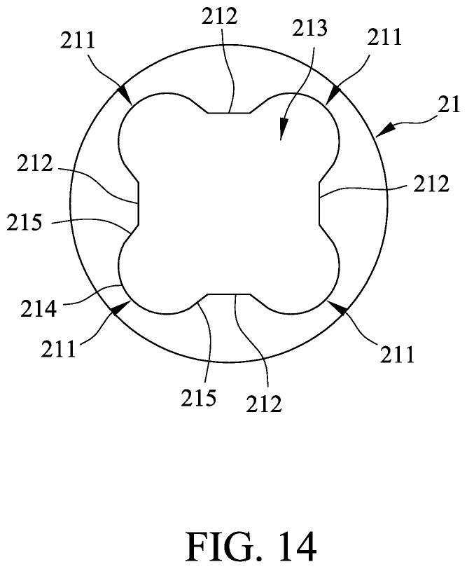

Referring to FIGS. 13 and 14, an embodiment of a driving tool 2 according to the disclosure is adapted for driving the fastener 1, and includes a main body 21. The main body 21 has four driving wall portions 211 and four guiding wall portions 212 that are disposed about a central axis of the driving tool 2 in an alternating arrangement. The driving wall portions 211 of the main body 21 are equiangularly spaced apart from each other. Each of the guiding wall portions 212 of the main body 21 is straight, and has two opposite ends that are respectively connected to two of the driving wall portions 211 of the main body 21 adjacent to the guiding wall portion 212 of the main body 21. The driving wall portions 211 and the guiding wall portions 212 of the main body 21 cooperatively define a driving socket 213. A ratio of a longest distance between two of the driving wall portions 211 of the main body 21 that are non-adjacent to each other to a longest distance between two of the driving wall portions 211 of the main body 21 that are adjacent to each other is greater than 1.16. Each of the driving wall portions 211 of the main body 21 has a curved section 214 that defines an arc of a circle and that has two opposite ends, and two straight sections 215 each of which extends from a respective one of the ends of the curved section 214 of the main body 21 and interconnects the respective one of the ends of the curved section 214 of the main body 21 and a respective one of two of the guiding wall portions 212 of the main body 21 adjacent to the driving wall portion 211 of the main body 21. A radius of curvature of the curved section 214 of each of the driving wall portions 211 of the main body 21 is greater than a length of each of the straight sections 215 of the driving wall portion 211 of the main body 21. A central angle of the curved section 214 of each of the driving wall portions 211 of the main body 21 is smaller than 180 degrees, an arc length of the curved section 214 of each of the driving wall portions 211 on an imaginary plane perpendicular to the central axis of the driving tool 2 is thus shorter than half of a circumference of the circle defined by the curved section 214 of the driving wall portion 211.

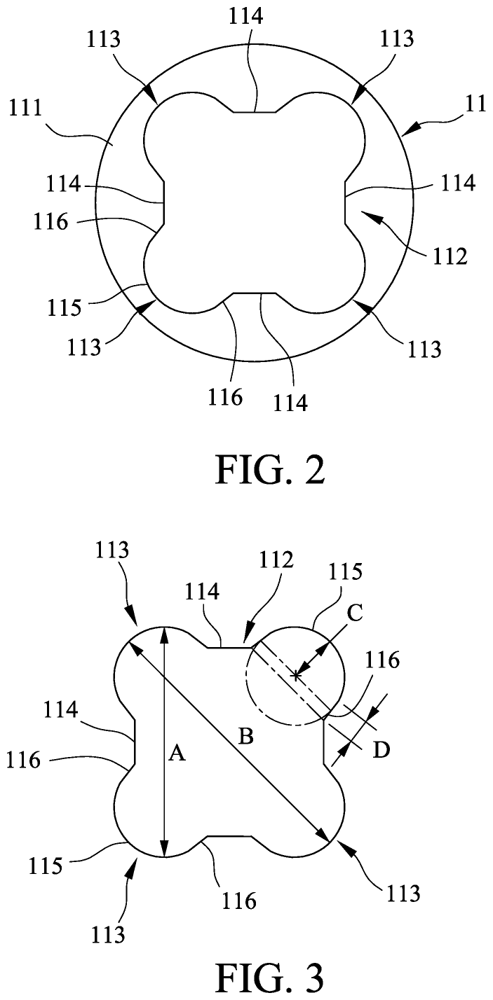

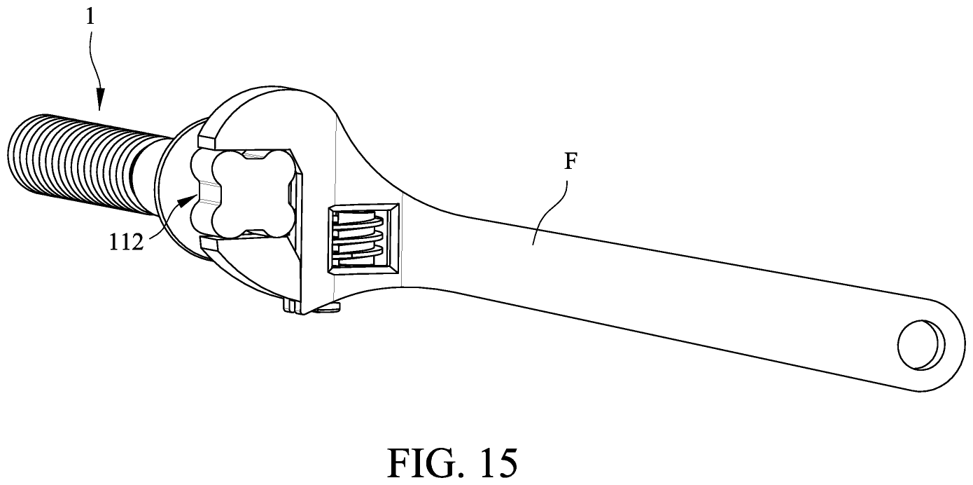

Referring further to FIG. 15, in cooperation with FIGS. 2 and 13, the driven protrusion 112 of the fastener 1 may be coupled to the driving socket 213 of the driving tool 2 that corresponds in shape thereto (i.e., the driving wall portions 211 and the guiding wall portions 212 of the driving tool 2 cooperatively surround the driven protrusion 112), or may be driven by a wrench (F) (see FIG. 15). By virtue of the ratio of the longest distance (B) between two of the driven wall portions 113 that are non-adjacent to each other to the longest distance (A) between two of the driven wall portions 113 that are adjacent to each other being greater than 1.16 and greater than a ratio of a distance across corners of a regular hexagon to a distance across flats of the regular hexagon, which is 1.1547, the likelihood that the driving tool 2 or the wrench (F) slips off the fastener 1 during operation may be greatly lowered. According to a test, a conventional wrench may slip off a conventional M10 flanged hexagon screw when a torque that is exerted on the conventional wrench is about 54 to 55 Newton meters (Nm). However, when the conventional wrench is used to drive the fastener 1 that has the same outer diameter as the conventional M10 flanged hexagon screw, the conventional wrench may not slip off the fastener 1 even when a torque that is exerted on the conventional wrench reaches a maximum torque that can be applied on the fastener 1 before failure of the fastener 1 occurs, which is 88 Nm. Thus, the fastener 1 provides better slip resistance.

Referring to FIGS. 2, 13 and 14 again, when a user rotates the fastener 1 via the driving tool 2, by virtue of the curved sections 115 of the fastener 1 and the curved sections 214 of the driving tool 2, the fastener 1 and the driving tool 2 may avoid abrasion and damage during the operation, and the torque exerted on the driving tool 2 may be sufficiently transmitted to the fastener 1. By virtue of the straight sections 116, 215, a contact area between the driving tool 2 and the fastener 1 is increased. Although manufacturing tolerance exists in the driving tool 2 and the fastener 1, the driving tool 2 and the fastener 1 may be able to fittingly engage with each other by the presence of the straight sections 116, 215 so that the torque exerted on the driving tool 2 may be sufficiently transmitted to the fastener 1, and that stability during the operation may be enhanced. Moreover, by virtue of the straight sections 116, the driven protrusion 112 of the fastener 1 may easily be separated from a mold during its manufacturing process. Thus, the mold for the driven protrusion 112 may avoid damage caused by failure to be separated from the driven protrusion 112, thereby increasing the service life of the mold for the fastener 1.

In summary, because the fastener 1 provides slip resistance and is able to avoid abrasion and damage during the operation, the user may use the conventional wrench instead of a power tool to drive the fastener 1 when there is not enough space to operate the power tool (e.g., when the fastener 1 has to be fastened to/removed from an object adjacent to the ground), and the torque exerted on the conventional wrench may still be sufficiently transmitted to the fastener 1 while the stability during the operation is provided, thereby making the operation with hand tools relatively easy. Furthermore, the end section 122 of the screw shank 12 may have different configurations according to the actual requirements so that the fastener 1 may be used for fastening different objects. The driven protrusion 112 may have the recess 117 that come in different shapes so that the common driver bit (E) may be inserted into the recess 117 to drive the fastener 1. Thus, the fastener 1 may be used for more purposes. Therefore, the purpose of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A fastener comprising:
a screw head including a driven protrusion that has four driven wall portions and four guiding wall portions which are disposed about a central axis of the fastener in an alternating arrangement, the driven wall portions being equiangularly spaced apart from each other, each of the guiding wall portions being straight and having two opposite ends that are respectively connected to two of the driven wall portions adjacent to the guiding wall portion, a ratio of a longest distance between two of the driven wall portions that are non-adjacent to each other to a longest distance between two of the driven wall portions that are adjacent to each other being greater than 1.16, each of the driven wall portions having a curved section that defines an arc of a circle and that has two opposite ends, and two straight sections each of which extends from a respective one of the ends of the curved section and interconnects the respective one of the ends of the curved section and a respective one of two of the guiding wall portions adjacent to the driven wall portion, a central angle of the curved section of each of the driven wall portions being smaller than 180 degrees; and
a screw shank extending from one side of the screw head that is distal from the driven protrusion of the screw head in an axial direction of the central axis, and having at least one thread that helically extends therealong.

2. The fastener as claimed in claim 1, wherein a radius of curvature of the curved section of each of the driven wall portions is greater than a length of each of the straight sections of the driven wall portion.

3. The fastener as claimed in claim 1, wherein the driven protrusion of the screw head has a surface opposite to the screw shank, and a recess that is recessed from the surface along the axial direction of the central axis.

4. The fastener as claimed in claim 3, wherein a cross section of the recess of the screw head on an imaginary plane perpendicular to the central axis is configured to be one of a hexagonal shape, a hexalobular shape, a cruciform shape, an asterisked shape, a quadrilateral shape, and a shape of a combination of a cross and a quadrilateral.

5. The fastener as claimed in claim 1, wherein the screw head further includes an abutment seat that is connected to the screw shank, the driven protrusion protruding from one side of the abutment seat opposite to the screw shank.

6. A driving tool adapted for driving the fastener as claimed in claim 1, the driving tool comprising:
a main body having four driving wall portions and four guiding wall portions that are disposed about a central axis of the driving tool in an alternating arrangement, the driving wall portions of the main body being equiangularly spaced apart from each other, each of the guiding wall portions of the main body being straight and having two opposite ends that are respectively connected to two of the driving wall portions of the main body adjacent to the guiding wall portion of the main body, the driving wall portions and the guiding wall portions of the main body cooperatively defining a driving socket, a ratio of a longest distance between two of the driving wall portions of the main body that are non-adjacent to each other to a longest distance between two of the driving wall portions of the main body that are adjacent to each other being greater than 1.16, each of the driving wall portions of the main body having a curved section that defines an arc of a circle and that has two opposite ends, and two straight sections each of which extends from a respective one of the ends of the curved section of the main body and interconnects the respective one of the ends of the curved section of the main body and a respective one of two of the guiding wall portions of the main body adjacent to the driving wall portion of the main body, a central angle of the curved section of each of the driving wall portions of the main body being smaller than 180 degrees.

7. The driving tool as claimed in claim 6, wherein a radius of curvature of the curved section of each of the driving wall portions of the driving tool is greater than a length of each of the straight sections of the driving wall portion of the driving tool.
